(19) United States
(12) Patent Application Publication
(10) Pub. No.: US 2026/0358230 A1
(43) Pub. Date: Nov. 12, 2026

(54) Population-Based Cell Classification

(71) Applicant: Beckman Coulter, Inc., Brea, CA (US)

(72) Inventors: Bian QIAN, Fort Lauderdale, FL (US); Jiuliu LU, Miami, FL (US)

(21) Appl. No.: 19/138,037

(22) PCT Filed: Dec. 22, 2023
(86) PCT No.: PCT/US2023/085714

§ 371 Date: Jun. 11, 2025

Related U.S. Application Data
(60) Provisional application No. 63/434,658, filed on Dec. 22, 2022.

(51) Int. Cl. G01N 15/1429; G01N 15/01; G06V 10/26; G06V 10/56; G06V 10/762; G06V 10/764; G06V 20/69

(52) U.S. Cl. CPC G01N 15/1429; G01N 15/01; G06V 10/26; G06V 10/56; G06V 10/762; G06V 10/764; G06V 20/693; G06V 20/695; G06V 20/698; G06V 2201/03

(57) ABSTRACT

Cell classification may be performed using a system which receives a set of images comprising representations for a plurality of cells, and which performs various acts of each of those cells. Those acts may include determining imaging parameters for each of those cells, generating a cluster assignment for each of those cells, and providing a type for each of those cells based on the cluster assignments.

### CROSS REFERENCE TO RELATED APPLICATIONS

This claims priority from, and is a nonprovisional of, provisional patent application 63/434,658, entitled “Population Based Cell Classification” and filed in the U.S. patent and trademark office Dec. 22, 2022. That application is hereby incorporated by reference in its entirety.

### BACKGROUND

Blood cell analysis is one of the most commonly performed medical tests for providing an overview of a patient's health status. A blood sample can be drawn from a patient's body and stored in a test tube containing an anticoagulant to prevent clotting. A whole blood sample normally comprises three major classes of blood cells including red blood cells (erythrocytes), white blood cells (leukocytes) and platelets (thrombocytes). Each class can be further divided into subclasses of members. For example, five major types or subclasses of white blood cells (WBCs) have different shapes and functions. White blood cells may include neutrophils, lymphocytes, monocytes, eosinophils, and basophils. There are also subclasses of the red blood cell types. The appearances of particles in a sample may differ according to pathological conditions, cell maturity and other causes. Red blood cell subclasses may include reticulocytes and nucleated red blood cells.

Traditionally particle classification systems have utilized non-imaging techniques, such as measuring light scatter from laser illumination, or changes in impedance as particles pass through an aperture. While these techniques can be effective, they do have drawbacks. Accordingly, there is a need for improved classification system, such as systems which can classify particles based on information extracted from images captured of those particles.

### SUMMARY

Described herein are devices, systems and methods for classifying objects such as cells in images captured by analyzers, such as a bioassay system which captures images of blood cells from a blood sample.

An illustrative implementation of such technology relates to a system comprising a processor, and a non-transitory computer readable medium. Such a medium may store instructions operable to, when executed by the processor, execute a set of acts. Such acts may comprise receiving a set of images, wherein the set of images comprise representations of a plurality of cells. Such acts may also comprise a set of acts performed for each cell from the plurality of cells. The set of acts may comprise determining one or more imaging parameters for that cell based on application of an image analysis algorithm. The set of acts may also comprise generating a cluster assignment for that cell by assigning that cell to a cluster from a plurality of clusters based on at least one of the one or more imaging parameters for both that cell and for a population comprising the plurality of cells. In other words, the set of acts may comprise generating a cluster assignment for that cell by assigning that cell to a cluster from a plurality of clusters based on at least one of the one or more imaging parameters for that cell and said at least one of the one or more imaging parameters for each cell of a cell population comprising the plurality of cells. Such a set of acts may also comprise providing a type for that cell based on the cluster assignment for that cell.

While multiple examples are described herein, still other examples of the described subject matter will become apparent to those skilled in the art from the following detailed description and drawings, which show and describe illustrative examples of disclosed subject matter. As will be realized, the disclosed subject matter is capable of modifications in various aspects, all without departing from the spirit and scope of the described subject matter. Accordingly, the drawings and detailed description are to be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a schematic illustration, partly in section and not to scale, showing operational aspects of an exemplary flow cell and high optical resolution imaging device for sample image analysis using digital image processing.

FIG. 2 illustrates a slide-based vision inspection system in which aspects of the disclosed technology may be used.

FIG. 3 illustrates a process which may be used to classify cells.

FIG. 4 illustrates a process which may be used to assign cells to clusters using a gating algorithm.

FIG. 5 illustrates a process which may be used to assign cells to clusters using a gating algorithm.

FIG. 6 illustrates an exemplary nucleus mask corresponding to the cell image of FIG. 7.

FIG. 7 illustrates a slide-based image of a cell including a nucleus.

FIG. 8 illustrates a cell mask for the image of the cell in FIG. 7.

FIG. 9 illustrates a histogram of each pixel value of the image of the cell in FIG. 7.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, compositions, and methods for analyzing a sample containing particles. In one embodiment, the invention relates to an automated particle imaging system which comprises an analyzer which may be, for example, a visual analyzer. In some embodiments, the visual analyzer may further comprise a processor to facilitate automated analysis of the images.

According to some aspects of this disclosure, a system comprising a visual analyzer may be provided for obtaining images of a sample comprising particles suspended in a liquid. Such a system may be useful, for example, in characterizing particles in biological fluids, such as detecting and quantifying erythrocytes, reticulocytes, nucleated red blood cells, platelets, and white blood cells, including white blood cell differential counting, categorization and subcategorization and analysis. Other similar uses such as characterizing blood cells from other fluids are also contemplated.

The classification of blood cells in a blood sample is an exemplary application for which the subject matter is particularly well suited, though other types of body fluid samples may be used. For example, aspects of the disclosed technology may be used in analysis of a non-blood body fluid sample comprising blood cells (e.g., white blood cells and/or red blood cells), such as serum, bone marrow, lavage fluid, effusions, exudates, cerebrospinal fluid, pleural fluid, peritoneal fluid, and amniotic fluid. It is also possible that the sample can be a solid tissue sample, e.g., a biopsy sample that has been treated to produce a cell suspension. The sample may also be a suspension obtained from treating a fecal sample. A sample may also be a laboratory or production line sample comprising particles, such as a cell culture sample. The term sample may be used to refer to a sample obtained from a patient or laboratory or any fraction, portion or aliquot thereof. The sample can be diluted, divided into portions, or stained in some processes.

In some aspects, samples are presented, imaged and analyzed in an automated manner. In the case of blood samples, the sample may be substantially diluted with a suitable diluent or saline solution, which reduces the extent to which the view of some cells might be hidden by other cells in an undiluted or less-diluted sample. The cells can be treated with agents that enhance the contrast of some cell aspects, for example using permeabilizing agents to render cell membranes permeable, and histological stains to adhere in and to reveal features, such as granules and the nucleus. In some cases, it may be desirable to stain an aliquot of the sample for counting and characterizing particles which include reticulocytes, nucleated red blood cells, and platelets, and for white blood cell differential, characterization and analysis. In other cases, samples containing red blood cells may be diluted before introduction to the flow cell and/or imaging in the flow cell or otherwise.

The particulars of sample preparation apparatus and methods for sample dilution, permeabilizing and histological staining, generally may be accomplished using precision pumps and valves operated by one or more programmable controllers. Examples can be found in patents such as U.S. Pat. No. 7,319,907. Likewise, techniques for distinguishing among certain cell categories and/or subcategories by their attributes such as relative size and color can be found in U.S. Pat. No. 5,436,978 in connection with white blood cells. The disclosures of these patents are hereby incorporated by reference in their entirety.

### I. IMAGING SYSTEMS

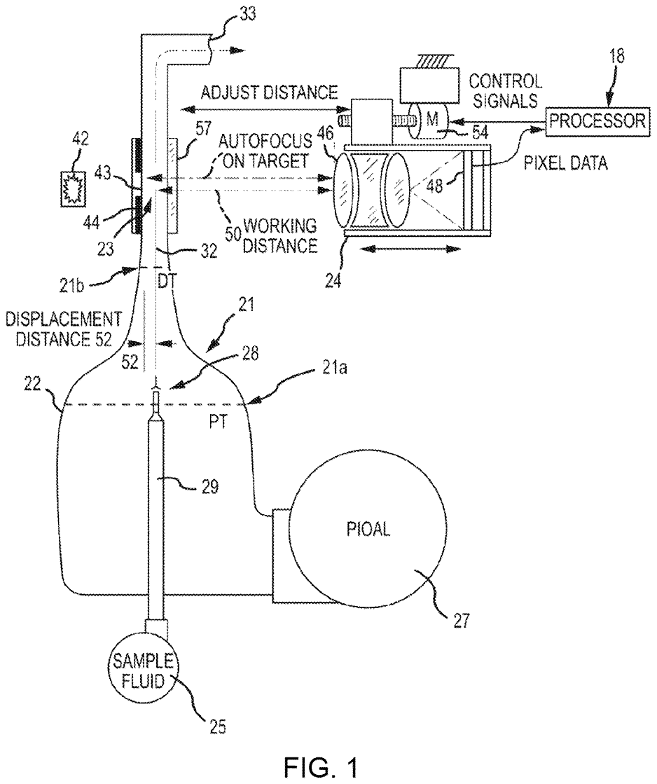

Turning now to the drawings, FIG. 1 schematically shows an exemplary flow cell 22 for conveying a sample fluid through a viewing zone 23 of a high optical resolution imaging device 24 in a configuration for imaging microscopic particles in a sample flow stream 32 using digital image processing. Flow cell 22 is coupled to a source 25 of sample fluid which may have been subjected to processing, such as contact with a particle contrast agent composition and heating. Flow cell 22 is also coupled to one or more sources 27 of a particle and/or intracellular organelle alignment liquid (PIOAL), such as a clear glycerol solution having a viscosity that is greater than the viscosity of the sample fluid.

The sample fluid is injected through a flattened opening at a distal end 28 of a sample feed tube 29, and into the interior of the flow cell 22 at a point where the PIOAL flow has been substantially established resulting in a stable and symmetric laminar flow of the PIOAL around/surrounding (e.g., circumferentially in a circular cross-sectional arrangement, or surrounding a plurality of sides of in a non-circular (e.g., rectangular) cross-sectional arrangement) the ribbon-shaped sample stream. The sample and PIOAL streams may be supplied by precision metering pumps that move the PIOAL with the injected sample fluid along a flowpath that narrows substantially. The PIOAL envelopes and compresses the sample fluid in the zone 21 where the flowpath narrows. Hence, the decrease in flowpath thickness at zone 21 can contribute to a geometric focusing of the sample stream 32. The sample fluid ribbon 32 is enveloped and carried along with the PIOAL downstream of the narrowing zone 21, passing in front of, or otherwise through the viewing zone 23 of, the high optical resolution imaging device 24 where images are collected, for example, using a CCD 48. In this way, flow imaging is performed where images from the flowing sample stream and the cellular material contained therein are collected. Processor 18 can receive, as input, pixel data from CCD 48. The sample fluid ribbon flows together with the PIOAL to a discharge 33.

As shown here, the narrowing zone 21 can have a proximal flowpath portion 21a having a proximal thickness PT and a distal flowpath portion 21b having a distal thickness DT, such that distal thickness DT is less than proximal thickness PT. The sample fluid can therefore be injected through the distal end 28 of sample tube 29 at a location that is distal to the proximal portion 21a and proximal to the distal portion 21b. Hence, the sample fluid can enter the PIOAL envelope as the PIOAL stream is compressed by the zone 21, wherein the sample fluid injection tube has a distal exit port through which sample fluid is injected into flowing sheath fluid, the distal exit port bounded by the decrease in flowpath size of the flow cell.

The digital high optical resolution imaging device 24 with objective lens 46 is directed along an optical axis that intersects the ribbon-shaped sample stream 32. The relative distance between the objective 46 and the flow cell 33 is variable by operation of a motor drive 54, for resolving and collecting a focused digitized image on a photosensor array. Additional information regarding the construction and operation of an exemplary flow cell such as shown in FIG. 1 is provided in U.S. Pat. No. 9,322,752, entitled “Flow cell Systems and Methods for Particle Analysis in Blood Samples,” filed on Mar. 17, 2014, the disclosure of which is hereby incorporated by reference in its entirety.

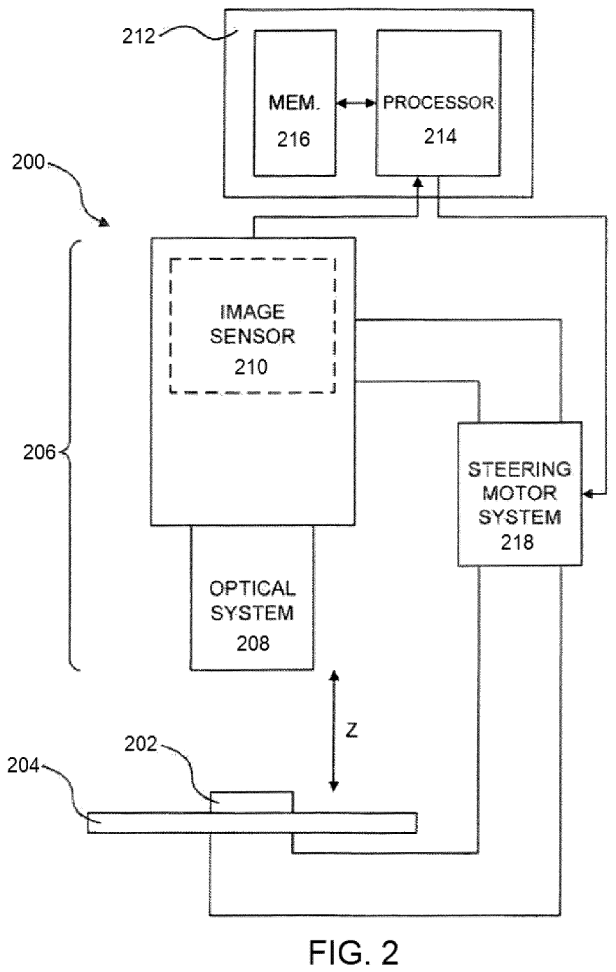

Aspects of the disclosed technology may also be applied in contexts other than flow cell systems such as shown in FIG. 1. For example, FIG. 2 illustrates a slide-based vision inspection system 200 in which aspects of the disclosed technology may be used. In the system shown in FIG. 2, a slide 202 comprising a sample, such as a blood sample, is placed in a slide holder 204. The slide holder 204 may be adapted to hold a number of slides or only one, as illustrated in FIG. 2. An image capturing device 206, comprising an optical system 208 and an image sensor 210, is adapted to capture image data depicting the sample in the slide 202.

The image data captured by the image capturing device 206 can be transferred to an image processing device 212. The image processing device 112 may be an external apparatus, such as a personal computer, connected to the image capturing device 206. Alternatively, the image processing device 212 may be incorporated in the image capturing device 206. The image processing device 212 can comprise a processor 214, associated with a memory 216, configured to determine changes needed to determine differences between the actual focus and a correct focus for the image capturing device 206. When the difference is determined an instruction can be transferred to a steering motor system 218. The steering motor system 218 can, based upon the instruction from the image processing device 212, alter the distance z between the slide 202 and the optical system 208. Descriptions of approaches which may be used for focusing using this type of setup are provided in U.S. provisional patent application 63/291,044 titled “Autofocusing Through Multi-Layer Processing,” filed on Dec. 17, 2021, U.S. Pat. No. 9,857,361 titled “Flowcell, sheath fluid, and autofocus systems and methods for particle analysis in urine samples”, filed on Mar. 17, 2014, U.S. Pat. No. 10,705,008 titled “autofocus systems and methods for particle analysis in blood samples”, filed on Mar. 17, 2014, U.S. Pat. No. 10,705,011, titled “Dynamic focus system and methods”, filed Oct. 5, 2017, and international application WO2023/150064 titled “Measure image quality of blood cell images”, filed Jan. 27, 2023, the disclosures of each of which are hereby incorporated by reference in their entirety.

### II. DATA PROCESSING

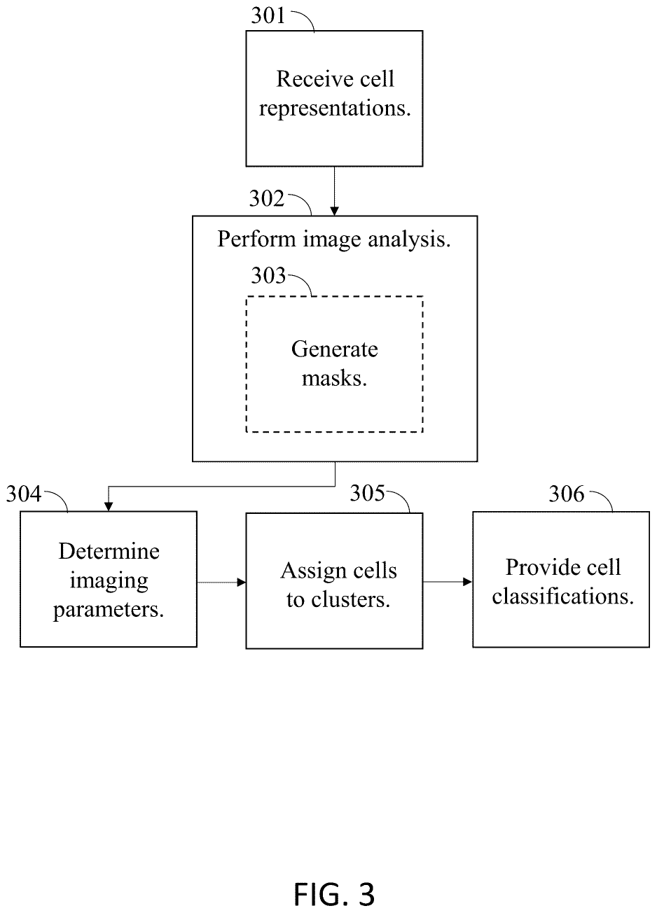

Data captured by systems such as shown in FIGS. 1 and 2 may be subjected to various types of processing. A high level method which may be performed in such processing is shown in FIG. 3, discussed below.

### A. Image Analysis

Initially, in the process of FIG. 3, representations of a plurality of cells would be received 301. This may comprise, for example, a processor receiving one or more images which each include representations of a plurality of cells (e.g., as may be captured in a slide-based system such as shown in FIG. 2). Alternatively, receiving 301 representations of a plurality of cells may comprise a processor receiving a plurality of images, each of which comprises a representation of only a single cell (e.g., as may be captured by a flow cell-based flow imaging system such as shown in FIG. 1). Once the representations had been received 301, the method may continue with performing 302 image analysis to obtain data which may be used in subsequent data processing. Exemplary data which may be obtained as a result of performing 302 image analysis is provided in table 1, below.

TABLE 1
Exemplary data which may be obtained by image analysis

| Data | Description |
|---|---|
| r | Red channel of an RGB image |
| g | Green channel of an RGB image |
| b | Blue channel of an RGB image |
| BG (or bg) | b/g (i.e., b divided by g, pixel-wise) |
| BR (or br) | b/r (i.e., b divided by r, pixel-wise) |
| RG (or rg) | r/g (i.e., r divided by g, pixel-wise) |
| lh | H channel in HSV color space |
| ls | S channel in HSV color space |
| lv | L* channel in L*a*b* color space |
| bmg | b-g (pixel-wise) |
| bmr | b-r (pixel-wise) |
| rmg | r-g (pixel-wise) |
| bkv | Mean of lv values of pixels on or close to |
| | (e.g., within 3 pixels of) the border of a cell |
| bkb | Mean of b values of pixels in an image which |
| | do not correspond to a depicted cell. |
| logfiltered | Result of applying Laplacian of Gaussian |
| | filter on g |
| logfilteredb | Result of applying Laplacian of Gaussian |
| | filter on b |

Other types of image analysis, such as isolating representations of cells using a cell isolation algorithm (e.g., an algorithm which thresholds an image captured by a flow cell-based system to identify portions of the image which do not represent a cell) and/or boundary identification using approaches such as described in U.S. Pat. No. 4,538,299, titled “method and apparatus for locating the boundary of an object”, issued Aug. 27, 1985, the disclosure of which is hereby incorporated by reference in its entirety, may also be included in performing 302 image analysis.

Additionally, in some embodiments, performing 302 image analysis may also include generating 303 masks. For example, the following masks may potentially be generated 303.

TABLE 2
Exemplary masks

| Mask | Description |
|---|---|
| background_mask | Pixels in an image which do not |
| | correspond to a depicted cell |
| cell_mask | Pixels in an image corresponding to a |
| | depicted cell |
| nucleus_mask | Pixels in an image corresponding to a |
| | cell nucleus |
| cytoplasm_mask | Pixels in an image which are in the |
| | cell_mask but not in the nucleus_mask. |
| darkmask_mask | Pixels in the cell_mask which have b |
| | values below a particular threshold (e.g., |
| | of less than the max of (a) 30^{th} percentile |
| | of b values in the nucleus mask and (b) |
| | bkv * 0.3) |
| black_pixel_mask | Pixels that are in the cell_mask and |
| | satisfy a particular color threshold (e.g., |
| | b-r < 35 and b-g < 35 and b < 170). |
| nonblack_mask | Pixels that are in nucleus_mask but not |
| | in black_pixel_mask. |
| shrink_nucleus_mask | Result of applying image erosion on |
| | nucleus_mask |
| dilate_nucleus_mask | Result of applying image dilation on |
| | nucleus_mask. |
| nucleus_bw_Half_mask | Pixels which are in the cell_mask and |
| | have a b value of less than the median |
| | of b values of pixels in nucleus_mask |
| edge_mask | Pixels in nucleus_mask but not in |
| | shrink_nucleus_mask |
| id_mask | Pixels in dilate_nucleus_mask, |
| | shrink_nucleus_mask, which has a |
| | corresponding logfiltered value of greater |
| | than 0 and a corresponding logfilteredb |
| | value of greater than 0. |

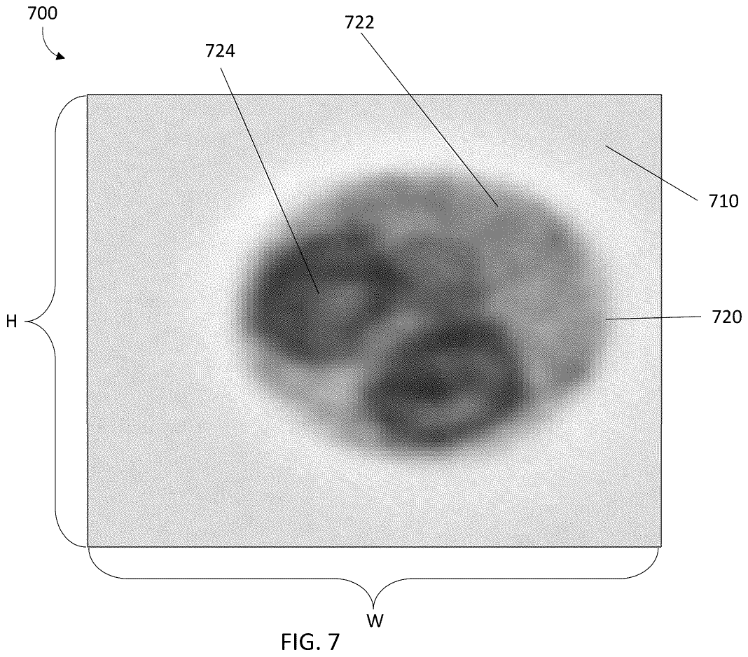

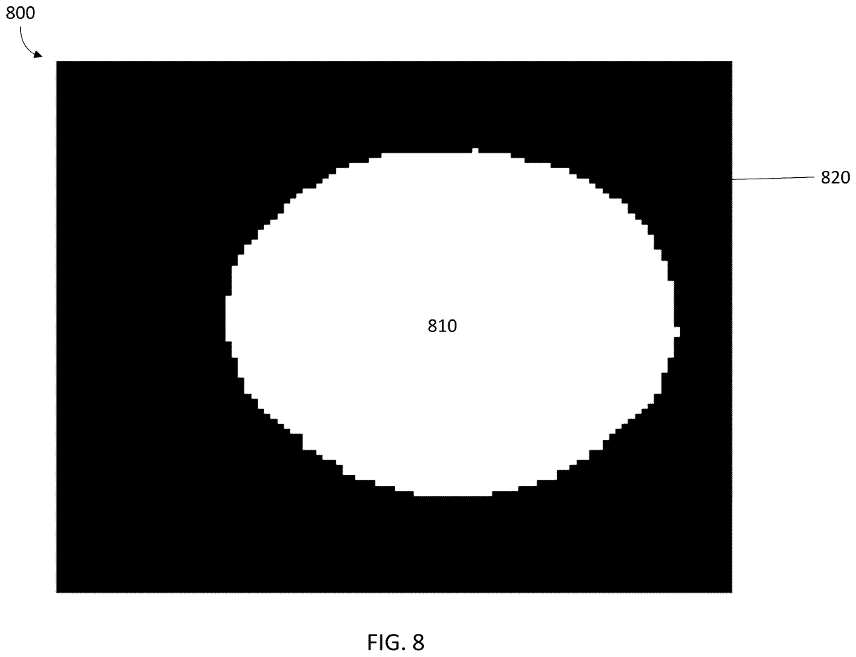

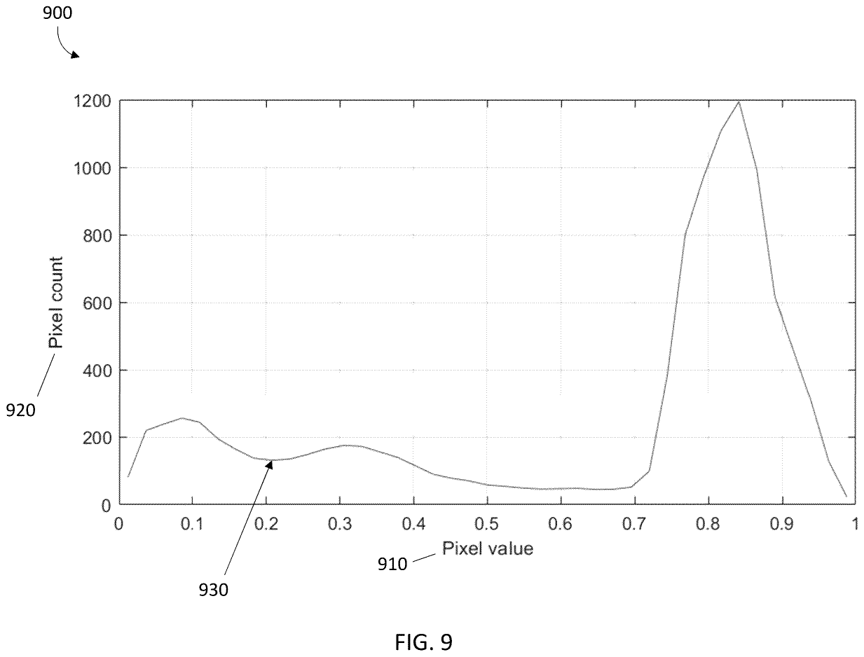

To illustrate what may be involved in generating 303 masks, FIG. 7 shows an image of a cell 700 such as may be captured using devices as shown in FIG. 1 or 2. In some embodiments, the image may comprise a background portion 710 and a foreground portion 720. The foreground portion 720, may represent a blood cell that may be further segmented into cell parts (e.g., cytoplasm 722 and nucleus 724). These components (e.g., cytoplasm 722 and nucleus 724) of the blood cell image 700 can be described, or defined, utilizing a corresponding mask. For example, referring briefly to FIG. 8, an illustrative example of a cell mask 800 (corresponding to cell_mask from table 2) is shown. In some embodiments, the mask may comprise binary values. For example, and as shown, cell mask 800 may be approximately the same size as the original image and use a series of 0's and/or 1's to represent each pixel. In some embodiments, a value of 1 may represent that the corresponding pixel belongs to the cell 810 while a value of 0 may represent that the corresponding pixel does not belong to the cell (e.g., a background mask 820). Such a cell mask may be created, for example, by normalizing pixel values in an RGB image and using the normalized value to create a histogram, and then using the histogram to define a threshold separating cell from non-cell pixels. An example of such a histogram is shown in FIG. 9, which depicts a graphical representation 900 plotting the normalized values 910 (e.g., minimum of red, green, and blue values smoothed by averaging values of neighboring pixels within a smoothing window and projected onto a 0:1 range) of the pixels versus the total number of pixels 920 having the corresponding value in the image.

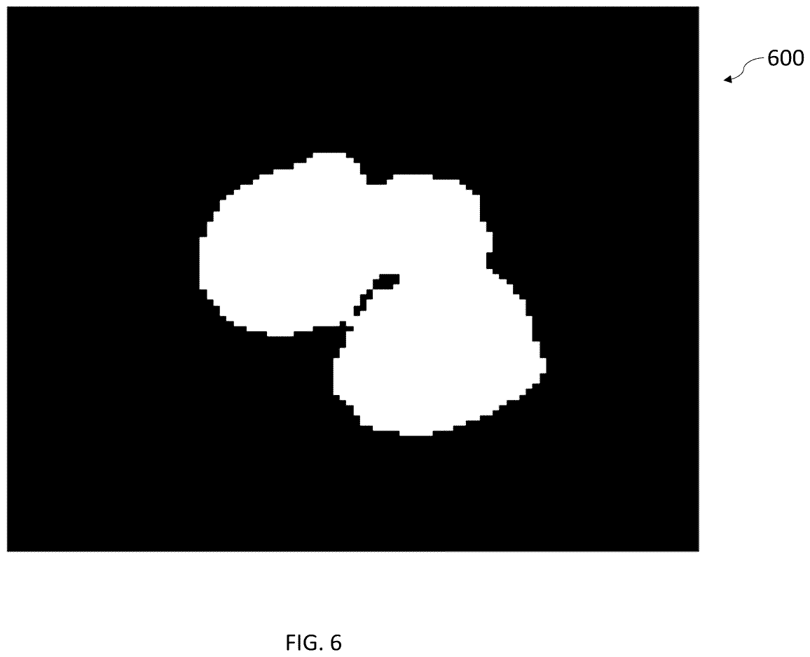

Other masks may be generated in manners similar to that discussed above for the cell mask, though the details for a particular mask will vary depending on the nature of the mask itself. For example, a nucleus mask 600 (corresponding to nucleus_mask in table 2) as shown in FIG. 6 may be defined using a left threshold 930 value in the histogram of FIG. 9, reflecting the fact that pixels depicting a nucleus are likely to be darker than the pixels depicting other portions of the cell. As another example, in some cases one mask may be generated using another mask and/or another mask's parameters as an input. For instance, a dark mask may be a mask of pixels within a cell mask whose values are below a first darkness threshold, while a black mask may be a mask of pixels which are within the cell mask, and which are below a second darkness threshold which is below the first darkness threshold. It is also possible that, in some cases, one or more other sets of pixels may be generated either in addition to, or as alternatives to, the masks described above. These may include, for example border pixels, and/or pixels corresponding to one or more of the listed masks (e.g., cytoplasm pixels, black pixels). Additionally, in some cases generating 303 masks may include processing beyond that based on pixel values. For example, in some cases, once a mask for a structure which would be expected to be continuous (e.g., a cell) is created, an anomaly removal step may be performed in which small (e.g., less than a specified number of pixel) holes in that mask would be removed (i.e., treated as being included regardless of the pixel value) so that the mask creation would not be adversely impacted by imaging or other artifacts. Accordingly, the above discussion of generating masks 603 should be understood as being illustrative only, and should not be treated as limiting.

### B. Determining Parameters

In the method of FIG. 3, after performing 302 image analysis (potentially including generating 303 masks) is complete the data obtained from the image analysis could be used in determining 304 imaging parameters. Examples of these types of parameters and how their values may be determined 304 are provided below in table 3:

TABLE 3
Exemplary parameters and methods of determination

| Parameter | Example determination/definition |
|---|---|
| Darkness of cell | Convert (if necessary) representation of cell to HSV format |
| | and treat difference between the average V value for the cell |
| | and 1 as the darkness of the cell. |
| Ratio of blue to red in the | Convert (if necessary) representation of cell to RGB format and |
| cell image (i.e., ratio of | use ratio of blue to red channel to determine this parameter. |
| blueness to redness) | |
| Light absorption due to cell | Determine the average brightness of non-cell portions of an |
| presence | image, and subtract the actual brightness of the |
| | representation of the cell in that image. |
| Ratio of blueness to | Convert (if necessary) representation of cell to RGB format and |
| greenness in the cell's | use ratio of blue to green channels to determine this parameter. |
| nucleus | |
| Granularity of the nucleus | Use object detection to identify the number of structural objects, |
| | such as holes, chromatin and nucleolus in the nucleus of the cell. |
| Darkness of granules and/or | Convert (if necessary) representation of cell to HSV format |
| cytoplasm | and treat difference between the average V value for the |
| | granules and/or cytoplasm and 1 as the darkness value. |
| Blueness of the granules | Convert (if necessary) representation of cell to RGB format |
| and/or cytoplasm | and use the blue channel of the representation of the granules |
| | or cytoplasm to determine this parameter. |
| Cell size (e.g., equivalent | Determine the diameter of a circle having the same |
| cell diameter) | cross-sectional area as the representation of the cell. |
| Number of dark blue | Identify granules in cellusing object detection, determine |
| granules around nucleus | which granules were dark blue (e.g., using the blue channel |
| | of an RGB representation of the cell, and using the |
| | relationship between the V value of an HSV representation |
| | of the cell and a threshold such as 0.5 to determine darkness) |
| | and count the number of such granules based on whether they |
| | are within a threshold distance (e.g., within ten pixels) of the |
| | edge of the nucleus. |
| Contrast of nucleus to | Convert (if necessary) representation of cell to HSV format and |
| cytoplasm | treat difference between the average V value for the nucleus |
| | and the average V value for the cytoplasm as the contrast. |
| Nucleus size (e.g., | Determine diameter of a circle have the same cross-sectional |
| equivalent nucleus diameter) | area as the nucleus in the representation of the cell. |
| Mask Nv (may be denoted | Mean of lv values of the pixels in the mask divided by bkv |
| by the name of the mask | |
| followed by _Nv) | |
| Mask br (may be denoted by | Mean of br values of the pixels in the mask |
| the name of the mask | |
| followed by _br) | |
| Mask blueness1 (may be | Mean of bmr values of pixels in the mask |
| denoted by the name of the | |
| mask followed | |
| by _blueness 1) | |
| Mask blueness2 (may be | Mean of bmg values of the pixels in the mask |
| denoted by the name of the | |
| mask followed | |
| by _blueness2) | |
| Mask effective diameter | Square root of the number of pixels in the mask multiplied |
| | by 4 and divided by pi. |
| edge_area | Number of pixels in edge_mask |
| center_area | Number of pixels in shrink_nucleus_mask |
| marked_edge_area | Number of pixels in both edge_mask and |
| | nucleus_bw_Half_mask |
| marked_center_area | Number of pixels in both shrink_nucleus_mask and |
| | nucleus_bw_ Half_mask |
| nucleus_contrast1 | (marked_edge_area/edge_area)/ |
| | (marked_center_area/center_area) |
| nucleus_contrast2 | Sum of logfilteredb values of pixels in id_mask divided by |
| | the sum of the logfiltered values of pixels in id_mask |
| normalized_y | Values of nucleus_mask_ED after having been subjected to |
| | normalization (e.g., 0 if nucleus_mask_ED is < 4, 1 if |
| | nucleus_mask_ED is greater than 10, and |
| | (nucleus_mask_ED − 4)/(10 − 4) otherwise) |
| normalized_x | Values of cell_mask_ED after having been subjected to |
| | normalization (e.g., 0 if cell_mask_ED is < 5, 1 if |
| | cell_mask_ED is greater than 14, and |
| | (cell_mask_ED − 5)/(14 − 5) otherwise) |

### C. Assigning Clusters

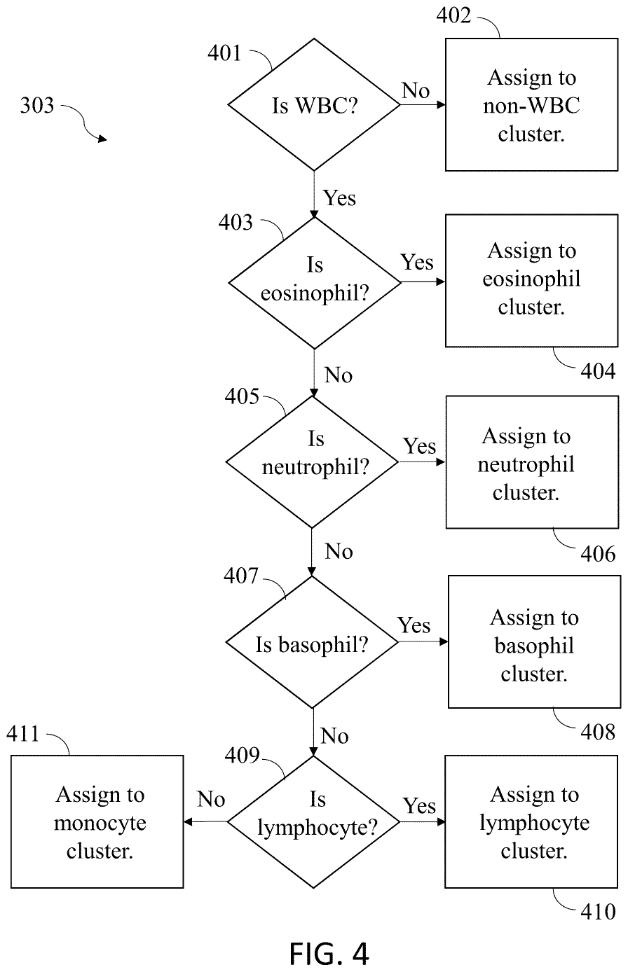

With the parameters determined 304, a process such as shown in FIG. 3 may continue with assigning 305 each of the cells to a cluster based on the imaging parameters. This may be done, for example, by applying a gating algorithm to the cell representations in which the previously determined parameters would be evaluated in sequence to assign the cells to various clusters. To illustrate, consider FIG. 4, which illustrates how such a gating approach may be applied to clustering of cells from a blood sample.

In the method of FIG. 4, initially, a check 401 may be applied to determine if a cell is or is not a white blood cell. This may be done using parameters such as the darkness of the cell, the ratio of its blueness to redness, and the light absorption due to its presence. For example, histograms may be created of the darkness, blueness-redness ratio, and/or light absorption values for the cells, and a lowest point in each of those histograms may be defined as a threshold for determining whether a cell is a white blood cell. With these thresholds, any cell which did not have a darkness value, a blueness-redness ratio, or a light absorption value above the cut-off for being treated as a white blood cell (e.g., cells where the blue channels divided by the red channels in their cell masks were less than 1, and where the mean of the L channel values of the pixels in their cell mask in L*a*b* color space divided by the mean of the L values of their border pixels in L*a*b color space is less than 1 could be classified as not being white blood cells) would be assigned 402 to a non-white blood cell cluster. Otherwise, the cell may be subjected to further analysis to determine what type of white blood cell it was.

In the method of FIG. 4, if a cell is determined 401 to be a white blood cell, a further determination 403 may be made of whether that cell is or is not an eosinophil. This may be done using parameters such as the darkness of the cell's granules, and the blueness of the cell's granules and/or cytoplasm. For example, Gaussian mixture model clustering may be used to cluster the cells in a two-dimensional space defined by the blueness of the cells' granules. The cells having the least blue granules may then be treated as eosinophils and assigned 404 to an eosinophil cluster. Similar processing may be applied to identify neutrophils. That is, after appropriate cells have been assigned 404 to the eosinophil cluster, a further determination 405 may be made of whether the remaining cells are or are not neutrophils by applying Gaussian mixture model clustering to cluster those cells in a three-dimensional space defined by the cells' size and the darkness and blueness of their cytoplasm. The relatively larger cells having fewer blue granules or cytoplasm at the same darkness levels (e.g., differences between V value in HSV color space and 1 for the applicable cells) may then be treated as neutrophils and assigned 406 to a neutrophil cluster.

In the method of FIG. 4, after cells have been assigned 406 to the neutrophil cluster as appropriate, the remaining cells may be subjected to a further determination 407 of whether or not they are basophils. This may be done, for example, by identifying the number of dark blue granules around the nucleus and using OPTICS clustering (as described in Kriegel, Hans-Peter; Kroger, Peer; Sander, Jorg; and Zimek, Arthur, Density-Based Clustering, Wiley Interdisciplinary Reviews: Data Mining and Knowledge Discovery. 1 (3): 231-240, the disclosure of which is hereby incorporated by reference in its entirety) or thresholding algorithm to identify those cells whose representations include a relatively large number of such granules. Those cells may then be assigned 408 to a basophil cluster, and a further determination 409 may be made of whether the remaining cells are monocytes or lymphocytes. This may be done by using k-means clustering to separate the cells based on their sizes and/or the sizes of their nuclei. The smaller cells (e.g., cells with a normalized_y value of <=0.42) may be assigned 410 to a lymphocyte cluster, with the remaining cells assigned 411 to a monocyte cluster. In this way, cells in a sample may be classified as non-WBC, eosinophils, neutrophils, basophils, lymphocytes, and monocytes using a series of binary classifications based on the relationships of relevant parameters for particular cells to those parameters for the overall population of cells being considered.

### D. Classification

Retuning now to the discussion of FIG. 3, after the cells had been assigned 305 to clusters, the cluster assignment may be used to provide 306 classifications for the cells. This may be done, for example, by providing output for a user (e.g., on a display) displaying the cells on a scatterplot, with different colors used to differentiate the types of cells from each other. Similarly, in some cases the classifications of cells may be provided to an evaluation algorithm which may use the classification to determine if there may be some abnormality in image evaluation. For example, an evaluation algorithm may be configured with data representing the characteristics and relative locations that would be expected for different clusters based on images captured in ideal conditions. In such a case, the cell classifications may be provided 306 to the evaluation algorithm which could compare the relative locations and characteristics of the clusters created from the images with the expected relative locations and characteristics. Based on this comparison, the evaluation algorithm may indicate if the cell representations were captured under less than ideal illumination (e.g., because the cells in the clusters appeared darker than expected), if the sample which was imaged was improperly stained (e.g., because the clusters appeared pale, which could result in the clusters being shifted on an axis representing the blueness or darkness of the cells), or if images were captured with improper focus (e.g., because the cell sizes in the various clusters appear larger than expected). An evaluation algorithm may also quantify the difference between actual and ideal conditions, such as by measuring shifts along various parameters across the entire population of cells represented by the clusters. This may then be used to provide various outputs, such as flagging samples which may need to be reimaged due to anomalies which exceeded some threshold magnitude, informing an operator that he or she should adjust the imaging components he or she is using to improve imagine quality going forward. Other applications of this type of information, such as providing evaluating the effectiveness of analysis systems as they are being developed, are also possible and will be immediately apparent to those of ordinary skill in the art in light of this disclosure. Accordingly, the examples provided should be understood as being illustrative only and should not be treated as limiting.

A relative distribution profile implemented based on this disclosure may offer advantages over a cell-by-cell classification system (e.g., identifying and classifying each cell one at a time). For instance, the chance of misclassification due to poor imaging conditions (e.g., a camera being out of focus, poor lighting, or problems with staining) is reduced as a classification system can identify a relative population distribution and look for population clusters within the overall population distribution to classify cells. In addition to the examples described above, instead of comparing an observed population distribution with an expected population distribution, a classification system can be trained to look for poolings or groupings of data and then segment cell populations this way (e.g., without a step of comparing to an expected distribution profile).

### III. VARIATIONS

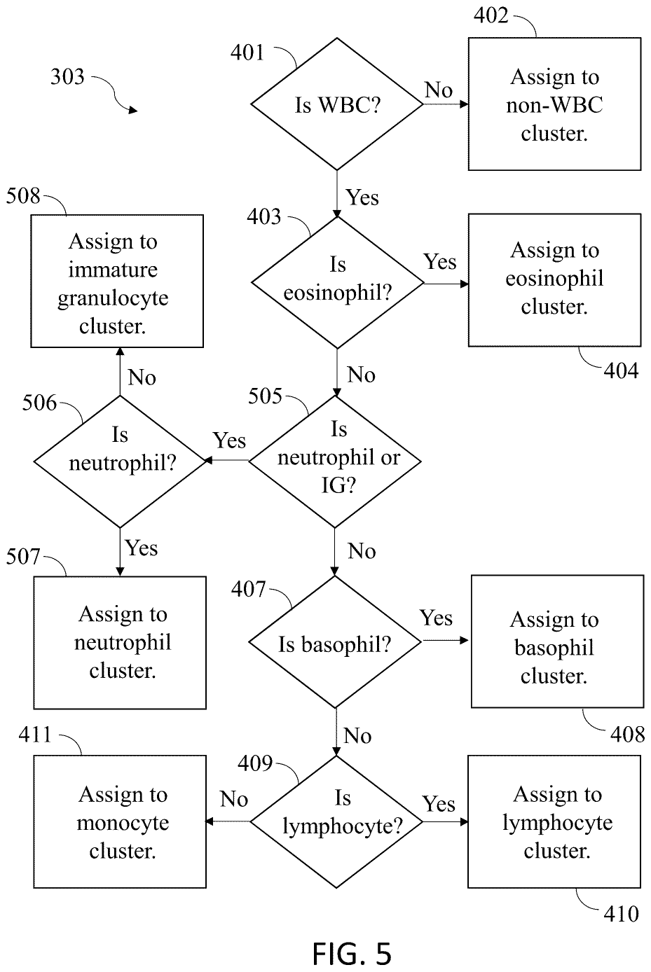

Other variations on, and implementation of, the disclosed technology are also possible. For instance, in some cases, cell isolation techniques such as described in the context of flow imaging may be applied to an image from a slide-based imaging system, and the individual cells may then be grouped into a population (potentially with other cells from different images for the same sample) as part of receiving cell representations 301. Also, in some implementations other types of classifications may also be performed in some cases. For instance, in some cases, prior to determining 403 whether cells which remained to be classified were eosinophils, a determination (not shown in FIG. 4) may be made of whether the cells are giant platelets based on whether they had relatively low granularities and/or ratios of blueness to greenness. Similarly, in some cases, a determination may be made as to whether one or more groups of cells should be identified as immature granulocytes. This may be done, for example, by using a process such as shown in FIG. 5. In that process, rather than simply determining 405 if cells should be treated as neutrophils as show in FIG. 4, a determination 505 is made of whether cells should be treated as potentially either being neutrophils or immature granulocytes. This determination 505 may be made, for example, using the same Gaussian mixture module clustering described in the context of FIG. 4, followed by making an additional determination 506 if the clustered cells were neutrophils by separating that cluster into two sub-clusters based on darkness and blueness. In this type of approach, cells which were relatively less bright and/or more blue may be assigned 507 to a cluster for neutrophils, while the remaining cells from the cluster identified in the previous determination 505 could be assigned 508 to an immature granulocyte (IG) cluster. Additional steps may also be included. For example, in some cases assignment 302 of cells to clusters may be made after excluding certain pixels from consideration, such as black pixels (which may be defined as pixels that have a low (e.g., less than 170) value in the blue channel of an RGB representation, along with having small (e.g., less than 35) differences between red and blue and red and green channels.

As another example of a type of variation, while different types of clustering were described above in the context of FIGS. 4 and 5, other approaches, such as agglomerative clustering or distribution-based clustering may also (or alternatively) be used. Similarly, in some cases, rather than assigning cells to clusters associated with specific types of cells using a gating approach such as described in the context of FIG. 4, cells may be clustered using parameters such as those described in table 3, and then, after all cells had been assigned to clusters, the clusters may be associated with different cell types based on their relative positions in feature space. Other variations, such as using sequential clustering and only determining characteristics (e.g., masks as shown in table 2, or features as shown in table 3) for a cell as those characteristics were being used to determine of the cell should be assigned to a cluster, will be immediately apparent to, and could be implemented without undue experimentation by, those of ordinary skill in the art based on this disclosure.

Another example of a type of variation is in the parameters which are determined 304 and/or used in assigning 305 cells to clusters. For example, in some systems implemented based on this disclosure the standard of various color values or combinations of color values in RGB images, or of other types of values from other images (e.g., L values of an L*a*b* image) could also be determined 304. These parameters (and other parameters in some cases) may be used in clustering and classification which may differ from that described above. For example, in some embodiments, a cell may be clustered into a White Blood Cell (WBC) or a non-WBC cluster depending on median BR-value (i.e., the blue channel divided by the red channel) and median NV-value (i.e., the mean of the L channel values in the cell mask divided by the mean of the L channel values in a border mask). For another example, the system may cluster a cell into an eosinophil cluster by utilizing a Gaussian Mixture Model (GMM) in a 2-dimensional features space with the first dimension being the mean of the blue channel values of the pixels in a dark mask divided by the mean of the blue channel values in the background mask and the second dimension being the mean of blue channel minus the red channel of any pixels in the dark mask that have blue channels lower than a threshold value (e.g., a value defined based on a percentage quantile for the mask). As another example, a system implemented based on this disclosure may cluster a cell into a basophil cluster by using a GMM in two dimensional feature space with the first dimension being nucleus_contrast1 and the second dimension being nucleus_contrast2. In some cases, cells may be classified into a lymphocyte-monocyte cluster by applying K-means clustering to a two dimensional feature space where the features are normalized_x and normalized_y with two targeted cluster. The cluster with the smaller normalized_x can be treated as the lymphocyte-monocyte cluster. This cluster can then be further broken down into lymphocytes and monocytes by treating calls with normalized_y values of <=0.42 as lymphocytes, and cells with normalized_y values of >0.42 as monocytes. There may also be clustering performed to separate neutrophils from immature granulocytes, with neutrophils and immature granulocytes being clustered using GMM in a two dimensional feature space where the first dimension is nonblack_mask_Nv and the second dimension is nonblack_mask_blueness2 (e.g., where the nonblack_mask is used to help identify specific cell types such as immature granulocytes). As yet another example, in some cases, clusters may be generated in the n-dimensional space defined by the determined 304 features, and the cells may be classified based on the relative locations of the clusters in that space.

Variations are also possible in the types of hardware used to implement the disclosed technology. For example, in some cases, image analysis tools, as well as other operations described in the context of FIGS. 3-9, may be applied using hardware which is incorporated into, or local to, analyzers which include imaging components such as shown in FIGS. 1-2. For example, features may be extracted from, and used to classify cells depicted in, images captured by an analyzer using a computer which is connected to the analyzer using a USB cable or over a local area network. Alternatively, in some cases images captured by an analyzer (or information extracted from such images) may be communicated to remote processing equipment, such as a cloud server, through a wide area network, and that equipment may be used to process the images (or information extracted from those images before transmission) and categorize the cells illustrated in the images.

### IV. EXAMPLES

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method of cell classification, comprising: receiving a set of images, wherein the set of images comprise representations of a plurality of cells; for each cell from the plurality of cells: determining one or more imaging parameters for that cell based on application of an image analysis algorithm; generating a cluster assignment for that cell by assigning that cell to a cluster from a plurality of clusters; and providing a type for that cell based on the cluster assignment for that cell.

### Example 2

The method of example 1, wherein, for each cell from the plurality of cells, generating the cluster assignment for that cell is performed using a gating algorithm which is configured to assign that cell to a cluster based on at least one of the one or more imaging parameters for both that cell and the population comprising the plurality of cells.

### Example 3

The method of example 2, wherein the gating algorithm is configured to assign cells to clusters corresponding to cell types by: first determining cells assigned to a non-white blood cell cluster; next determining cells assigned to an eosinophil cluster; next determining cells assigned to a neutrophil cluster; next determining cells assigned to a basophil cluster; next determining cells assigned to a lymphocyte cluster; and next determining cells assigned to a monocyte cluster.

### Example 4

The method of any of examples 2-3, wherein, for each cell from the plurality of cells, determining one or more imaging parameters for that cell based on application of the image analysis algorithm comprises: generating a plurality of masks for that cell; and for each of the plurality of masks, determining, for each of a plurality of features, a value for that feature, for that mask.

### Example 5

The method of example 4, wherein, for each cell from the plurality of cells, the plurality of clusters comprises a first cluster to which the gating algorithm is configured to determine whether to assign that cell based on: a first imaging parameter based on values of pixels in RGB color space from a cell mask for that cell; and a second imaging parameter based on values of pixels in L*a*b color space for the cell mask for that cell.

### Example 6

The method of any of examples 4-5, wherein, for each cell from the plurality of cells, the plurality of masks for that cell comprise: a cell mask; a nucleus mask; a cytoplasm mask; a dark mask; a black mask; and an IG mask.

### Example 7

The method of any of claims 1-6, wherein the one or more imaging parameters comprise at least two of: size, shape, darkness, color and internal structure.

### Example 8

The method of any of claims 1-7, wherein the set of acts comprises extracting the representations of the plurality of cells from the set of images based on application of a cell isolation algorithm.

### Example 9

The method of any of examples 1-8, wherein the method comprises capturing the set of images by performing acts comprising: establishing a flow of alignment fluid from an alignment fluid reservoir into a flow cell; creating a sample stream comprising sample fluid and a sheath of alignment fluid on opposite sides of the sample fluid based on injecting the sample fluid from a channel into the flow of alignment fluid; and using a camera focused on a viewing area of the flow cell to capture the set of images as the sample stream is flowing through the viewing area of the flow cell.

### Example 10

The method of any of examples 1-9, wherein the plurality of cells comprises blood cells.

### Example 11

The method of example 10, wherein: the plurality of cells comprises a first white blood cell and a second white blood cell; and the type for the first white blood cell is different from the type for the second white blood cell.

### Example 12

A system for cell classification, comprising: one or more processors; and a non-transitory computer readable medium having stored thereon instructions operable to, when executed by the one or more processors, perform a set of acts comprising: receiving a set of images, wherein the set of images comprise representations of a plurality of cells; for each cell from the plurality of cells: determining one or more imaging parameters for that cell based on application of an image analysis algorithm; generating a cluster assignment for that cell by assigning that cell to a cluster from a plurality of clusters based on at least one of the one or more imaging parameters for both that cell and for a population comprising the plurality of cells; and providing a type for that cell based on the cluster assignment for that cell.

### Example 13

The system of example 12, wherein, for each cell from the plurality of cells, the instructions are operable to, when executed by the one or more processors, generate the cluster assignment for that cell using a gating algorithm which is configured to assign that cell to a cluster based on the at least one of the one or more imaging parameters for both that cell and the population comprising the plurality of cells.

### Example 14

The system of example 13, wherein the gating algorithm is configured to assign cells to clusters corresponding to cell types by: first determining cells assigned to a non-white blood cell cluster; next determining cells assigned to an eosinophil cluster; next determining cells assigned to a neutrophil cluster; next determining cells assigned to a basophil cluster; next determining cells assigned to a lymphocyte cluster; and next determining cells assigned to a monocyte cluster.

### Example 15

The system of any of examples 13-14, wherein, for each cell from the plurality of cells, determining one or more imaging parameters for that cell based on application of the image analysis algorithm comprises: generating a plurality of masks for that cell; and for each of the plurality of masks, determining, for each of a plurality of features, a value for that feature, for that mask.

### Example 16

The system of example 15, wherein, for each cell from the plurality of cells, the plurality of clusters comprises a first cluster to which the gating algorithm is configured to determine whether to assign that cell based on: a first imaging parameter based on values of pixels in RGB color space from a cell mask for that cell; and a second imaging parameter based on values of pixels in L*a*b color space for the cell mask for that cell.

### Example 17

The system of any of examples 15-16, wherein, for each cell from the plurality of cells, the plurality of masks for that cell comprise: a cell mask; a nucleus mask; a cytoplasm mask; a dark mask; a black mask; and an IG mask.

### Example 18

The system of any of examples 12-17, wherein the one or more imaging parameters comprise at least two of: size, shape, darkness, color and internal structure.

### Example 19

The system of any of examples 12-18, wherein the set of acts comprises extracting the representations of the plurality of cells from the set of images based on application of a cell isolation algorithm.

### Example 20

The system of any of examples 12-19, wherein: the system comprises a flow cell and a camera configured to capture the set of images via flow imaging of a sample stream as it passes through a viewing area of the flow cell; and each image from the set of images comprises a representation of a single cell from the plurality of cells.

### Example 21

The system of example 20, wherein the system comprises an alignment fluid reservoir in fluid communication with the viewing area of the flow cell, and a channel adapted to inject sample fluid into a flow of the alignment fluid, thereby forming a sample stream comprising the sample fluid and a sheath of alignment fluid surrounding the sample fluid.

### Example 22

The system of any of examples 12-21, wherein the plurality of cells comprises blood cells.

### Example 23

The system of example 22, wherein: the plurality of cells comprises a first white blood cell and a second white blood cell; and the type for the first white blood cell is different from the type for the second white blood cell.

### Example 24

A machine comprising: a camera; and means for classifying cells in images captured by the camera.

### Example 25

A system for cell classification, comprising: a flow cell configured to flow a sample stream therethrough; a camera configured to capture one or more images of a plurality of cells from the sample stream; a processor; and a non-transitory computer readable medium having stored thereon instructions operable to, when executed by the processor, perform a set of acts comprising: determining one or more imaging parameters of the plurality of cells using an image analysis algorithm; identifying a plurality of data clusters within a population distribution for at least one of the one or more imaging parameters; assigning, to each cell of the plurality of cells, a cell type based on a data cluster from the plurality of data clusters in which that cell is comprised.

### Example 26

A system for cell classification, comprising: a processor; a non-transitory computer readable medium storing computer executable code comprising instructions that when executed by the processor, perform a set of acts comprising: receiving one or more images, the one or more images depicting a plurality of cells; determining one or more imaging parameters of the plurality of cells; identifying a plurality of data clusters within a population distribution, the population distribution established from at least one of the one or more imaging parameters; and assigning, to each data cluster from the plurality of data clusters, a corresponding cell type for that data cluster.

### Example 27

A system for cell classification comprising: a flow cell configured to flow a sample stream therethrough; a camera configured to capture one or more images of a plurality of cells in the sample stream; a processor; a non-transitory computer readable medium storing computer executable code comprising instructions that when executed by the processor, perform a set of acts comprising: determining one or more imaging parameters of the plurality of cells; identifying a plurality of data clusters within a population distribution, the population distribution established from at least one of the one or more imaging parameters; and assigning, to each data cluster from the plurality of data clusters, a corresponding cell type for that data cluster.

### Example 28

A method of cell classification, comprising: flowing a sample stream through a flow cell; utilizing a camera to capture one or more images of a plurality of cells from the sample stream as the sample stream flows through a viewing area of the flow cell; determining one or more imaging parameters of the plurality of cells using an image analysis algorithm; identifying a plurality of data clusters within a population distribution for at least one of the one or more imaging parameters; and assigning, to each cell of the plurality of cells, a cell type based on a data cluster from the plurality of data clusters in which that cell is comprised.

### Example 29

A method of cell classification, comprising: utilizing a camera to capture one or more images of a plurality of cells; determining one or more imaging parameters of the plurality of cells; identifying a plurality of data clusters within a population distribution, the population distribution established from at least one of the one or more imaging parameters; and assigning, to each data cluster from the plurality of data clusters, a corresponding cell type for that data cluster.

### Example 30

A method of cell classification, comprising: flowing a sample stream through a flow cell; utilizing a camera to capture one or more images of a plurality of cells in the sample stream as the sample stream flows through a viewing area of the flow cell; determining one or more imaging parameters of the plurality of cells; identifying a plurality of data clusters within a population distribution, the population distribution established from at least one of the one or more imaging parameters; and assigning, to each data cluster from the plurality of data clusters, a corresponding cell type for that data cluster.

### V. INTERPRETATION

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general purpose dictionary, except that when a term or phrase is indicated as having a particular meaning under the heading Explicit Definitions, it should be understood as having that meaning when used in the claims.

### EXPLICIT DEFINITIONS

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and the claims, the phrase “means for classifying cells in images captured by the camera” is a means plus function limitations as provided for in 35 U.S.C. § 112(f), in which the function is “classifying cells in images captured by the camera” and the corresponding structure is a computer configured to use an algorithm as illustrated in FIGS. 3, 4 and 5 and described in the accompanying description.

It should be understood that, in the above examples and claims, the term “set” should be understood as one or more things which are grouped together.

1. A method of cell classification, comprising:
receiving a set of images, wherein the set of images comprise representations of a plurality of cells;
for each cell from the plurality of cells:
determining one or more imaging parameters for that cell based on application of an image analysis algorithm;
generating a cluster assignment for that cell by assigning that cell to a cluster from a plurality of clusters; and
providing a type for that cell based on the cluster assignment for that cell.

2. The method of claim 1, wherein, for each cell from the plurality of cells, generating the cluster assignment for that cell is performed using a gating algorithm which is configured to assign that cell to a cluster based on at least one of the one or more imaging parameters for both that cell and the population comprising the plurality of cells.

3. The method of claim 2, wherein the gating algorithm is configured to assign cells to clusters corresponding to cell types by:
first determining cells assigned to a non-white blood cell cluster;
next determining cells assigned to an eosinophil cluster;
next determining cells assigned to a neutrophil cluster;
next determining cells assigned to a basophil cluster;
next determining cells assigned to a lymphocyte cluster; and
next determining cells assigned to a monocyte cluster.

4. The method of claim 2, wherein, for each cell from the plurality of cells, determining one or more imaging parameters for that cell based on application of the image analysis algorithm comprises:
generating a plurality of masks for that cell; and
for each of the plurality of masks, determining, for each of a plurality of features, a value for that feature, for that mask.

5. The method of claim 4, wherein, for each cell from the plurality of cells, the plurality of clusters comprises a first cluster to which the gating algorithm is configured to determine whether to assign that cell based on:
a first imaging parameter based on values of pixels in RGB color space from a cell mask for that cell; and
a second imaging parameter based on values of pixels in L*a*b color space for the cell mask for that cell.

6. The method of claim 4, wherein, for each cell from the plurality of cells, the plurality of masks for that cell comprise:
a cell mask;
a nucleus mask;
a cytoplasm mask.

7. The method of claim 1, wherein the one or more imaging parameters comprise at least two of: size, shape, darkness, color and internal structure.

8. The method of claim 1, wherein the set of acts comprises extracting the representations of the plurality of cells from the set of images based on application of a cell isolation algorithm.

9. The method of claim 1, wherein the method comprises capturing the set of images by performing acts comprising:
establishing a flow of alignment fluid from an alignment fluid reservoir into a flow cell; creating a sample stream comprising sample fluid and a sheath of alignment fluid surrounding the sample fluid based on injecting the sample fluid from a channel into the flow of alignment fluid; and
using a camera focused on a viewing area of the flow cell to capture the set of images as the sample stream is flowing through the viewing area of the flow cell.

10. The method of claim 1, wherein the plurality of cells comprises blood cells.

11. The method of claim 10, wherein:
the plurality of cells comprises a first white blood cell and a second white blood cell; and
the type for the first white blood cell is different from the type for the second white blood cell.

12. A system for cell classification, comprising:
one or more processors; and
a non-transitory computer readable medium having stored thereon instructions operable to, when executed by the one or more processors, perform a set of acts comprising:
receiving a set of images, wherein the set of images comprise representations of a plurality of cells;
for each cell from the plurality of cells:
determining one or more imaging parameters for that cell based on application of an image analysis algorithm;
generating a cluster assignment for that cell by assigning that cell to a cluster from a plurality of clusters based on at least one of the one or more imaging parameters for both that cell and for a population comprising the plurality of cells; and
providing a type for that cell based on the cluster assignment for that cell.

13. The system of claim 12, wherein, for each cell from the plurality of cells, the instructions are operable to, when executed by the one or more processors, generate the cluster assignment for that cell using a gating algorithm which is configured to assign that cell to a cluster based on the at least one of the one or more imaging parameters for both that cell and the population comprising the plurality of cells.

14. The system of claim 13, wherein the gating algorithm is configured to assign cells to clusters corresponding to cell types by:
first determining cells assigned to a non-white blood cell cluster;
next determining cells assigned to an eosinophil cluster;
next determining cells assigned to a neutrophil cluster;
next determining cells assigned to a basophil cluster;
next determining cells assigned to a lymphocyte cluster; and
next determining cells assigned to a monocyte cluster.

15. The system of claim 13, wherein, for each cell from the plurality of cells, determining one or more imaging parameters for that cell based on application of the image analysis algorithm comprises:
generating a plurality of masks for that cell; and
for each of the plurality of masks, determining, for each of a plurality of features, a value for that feature, for that mask.

16. The system of claim 15, wherein, for each cell from the plurality of cells, the plurality of clusters comprises a first cluster to which the gating algorithm is configured to determine whether to assign that cell based on:
a first imaging parameter based on values of pixels in RGB color space from a cell mask for that cell; and
a second imaging parameter based on values of pixels in L*a*b color space for the cell mask for that cell.

17. The system of claim 15, wherein, for each cell from the plurality of cells, the plurality of masks for that cell comprise:
a cell mask;
a nucleus mask;
a cytoplasm mask.

18. (canceled)

19. The system of claim 12, wherein the set of acts comprises extracting the representations of the plurality of cells from the set of images based on application of a cell isolation algorithm.

20. The system of claim 12, wherein:
the system comprises a flow cell and a camera configured to capture the set of images via flow imaging of a sample stream as it passes through a viewing area of the flow cell; and
each image from the set of images comprises a representation of a single cell from the plurality of cells.

21. The system of claim 20, wherein the system comprises an alignment fluid reservoir in fluid communication with the viewing area of the flow cell, and a channel adapted to inject sample fluid into a flow of the alignment fluid, thereby forming a sample stream comprising the sample fluid and a sheath of alignment fluid surrounding the sample fluid.

22-24. (canceled)
